(19) United States
(12) Patent Application Publication
(10) Pub. No.: US 2018/0089749 A1
(43) Pub. Date: Mar. 29, 2018

(54) MICRO STORE LOCATION PROJECTOR

(71) Applicant: Wal-Mart Stores, Inc., Bentonville, AR (US)

(72) Inventors: Matthew Dwain Biermann, Fayetteville, AR (US); Steven Lewis, Bentonville, AR (US); Nicholaus Adam Jones, Fayetteville, AR (US)

(21) Appl. No.: 15/690,758

(22) Filed: Aug. 30, 2017

Related U.S. Application Data
(60) Provisional application No. 62/401,510, filed on Sep. 29, 2016.

(51) Int. Cl. G06Q 30/06; G01C 21/20; H04W 4/04

(52) U.S. Cl. CPC G06Q 30/0639; G06Q 10/087; H04W 4/04; G01C 21/206

(57) ABSTRACT

A system for illuminating a route to a desired product within a retail store to assist a customer in finding a desired product is disclosed. Preferably, the system uses an App which is downloaded and installed on the customer's mobile device. The App may use locating capabilities of the mobile device to determine the customer's location. The store at which the customer is interested in finding the product is automatically provided based upon the user's location. The mobile device connects with a backend system which locates an item related database for the selected store. The customer selects the desired product and the product location in the store. A route from the customer's location to the product location is determined and displayed on the mobile device. The backend system employs a number of projector to project lighted markers on surfaces indicating the route for the customer to follow to the product.

### RELATED APPLICATIONS

This application claims the benefit of U.S. Provisional Patent No. 62/401,510, filed Sep. 29, 2016, entitled “Micro Store Location Projector,” the contents of which are incorporated by reference herein in their entirety.

### FIELD

Aspects of the present invention relate to a system for assisting a customer in finding a desired product within a retail store and more specifically to a system for assisting a customer in finding a desired product by displaying a lighted path to the product.

### BACKGROUND

Stores, such as retail department stores, are increasing in size and have an increasing number of departments and products (items for sale). In these large stores, customers have a hard time finding a specific department and/or item.

Store layouts are changed from time to time for various reasons. A customer that is familiar with a specific store layout becomes confused when the layout changes and has a more difficult time finding specific items/departments.

Smartphones now have GPS location determination capabilities. The GPS can be used to guide the users of the phones to specific locations. However, GPS is not accurate enough to identify item locations within a store. Therefore, the customer must ask an associate employed by the store for assistance.

Some customers are too shy to ask associates for directions and become frustrated trying to find the desired item/department. When customers do ask associates for directions, they redirect the associates from other tasks they could be doing, reducing the productivity of the associate.

Since associates vary in their ability to articulate directions to customers, sometimes the customer still cannot find the desired item/department.

Currently, there is a need for a system which will automatically and clearly indicate directions to a specific item and/or department in a store.

### BRIEF SUMMARY

According to aspects of the present inventive concepts there is provided an apparatus and method as set forth in the appended claims. Other features of the inventive concepts will be apparent from the dependent claims, and the description which follows.

The proposed system would be comprised of two parts. First would be a mobile app that is tied into the store which would allow customers to first look up an item or general location in their store. Second would be a system of ceiling-mounted, high-powered, miniature projectors or lasers that can project direction information onto bands of special labels which act as projector screens along the aisles which would indicate to the customer which way to go to find the area or item they are looking for.

Different colored beams of lights or icons could be used to discern between multiple customers using the system.

This system can also be used for guidance in emergency situations for helping to show the path to the closest open exit. A path is lighted from the customer's current position to the nearest available exit.

In an alternative embodiment, a plurality of lighted paths starting from most departments and locations in the building to the nearest exit are lighted.

In one example, the invention of the current application may be described as a method of illuminating a route to a desired product within a retail store to assist a customer having a mobile device in finding a desired product by activating executable code on the customer's mobile device, identifying a store in which the customer would like to find the desired product, and interacting with an item related database of the identified store to find the location of the product, if it exists. Next a route from the customer's location to the product location is identified. A projector, preferably one of a plurality of ceiling-mounted pico projectors, is operated to project lighted markers indicating the route to follow to the product.

The invention of the current application may also be described as a method of illuminating a route to a desired product within a retail store to assist a customer in finding a desired department within a retail store by activating executable code on the customer's smartphone, identifying a store in which to find the desired department, interacting with an item related database of the identified store to find the location of the product, if it exists, and identifying a route to the department location. The projectors, preferably a number of projectors mounted together on the ceiling, are operated to project lighted markers indicating the route to follow to the department.

An embodiment of the invention of the current application may be described as a locating system for assisting a customer in finding a desired product within a retail store employing a customer's mobile device, a projecting device adapted to project lighted markers on surfaces, and a backend system. The customer's mobile device includes an input/output (I/O) device adapted to provide output to the customer and receive input from the customer, a memory storing executable code and data, a communication device adapted to wirelessly communicate with other computing devices and a processor. The processor is coupled to the I/O device, the memory and the communication device and is adapted to interact with the customer to provide information on a desired store, and interact with the customer to provide information on a desired product.

The backend system employs a retail store database having information on a plurality of retail stores and their locations and floorplan layouts, at least one item related database having information on products offered by the stores in the retail store database, at least one projector adapted to project lighted markers on a surface and a controller. The controller is adapted to receive information on the desired store from the customer's mobile device, find the store in the retail store database corresponding to the received information, access a layout for the retail store found, receive information on the desired product in the desired store from the customer through the customer's mobile device, find a product location in the item related database associated with the desired product, if it exists, determine a route through the retail store layout to the product location; and activate the projecting device to project lighted markers identifying the route.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 is a block diagram of the major elements of a system according to one embodiment of the current invention.

FIG. 2 is a flowchart illustrating the steps of a method according to the current invention.

FIG. 3 is an illustration of the system projecting lighted indicators on reflective strips 141 on shelving to guide a customer to a location of a desired product, department or other location chosen by the customer (referred to as a “target location”).

### DETAILED DESCRIPTION

As indicated above, the location system according to the current invention overcomes many of the problems described in the ‘Background’ above.

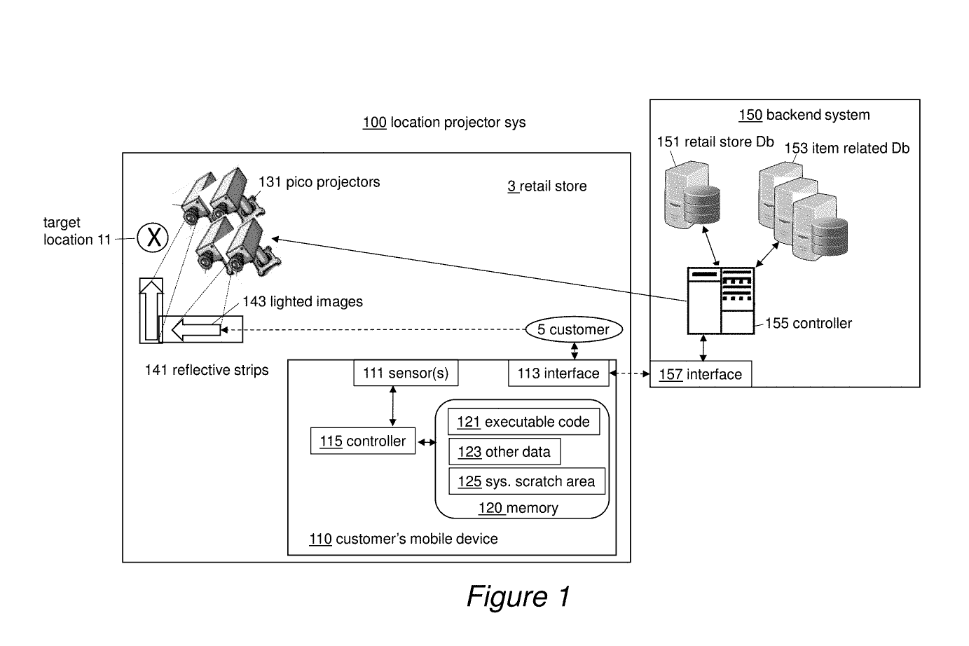

FIG. 1 is a block diagram of the major elements of a system according to one embodiment of the current invention.

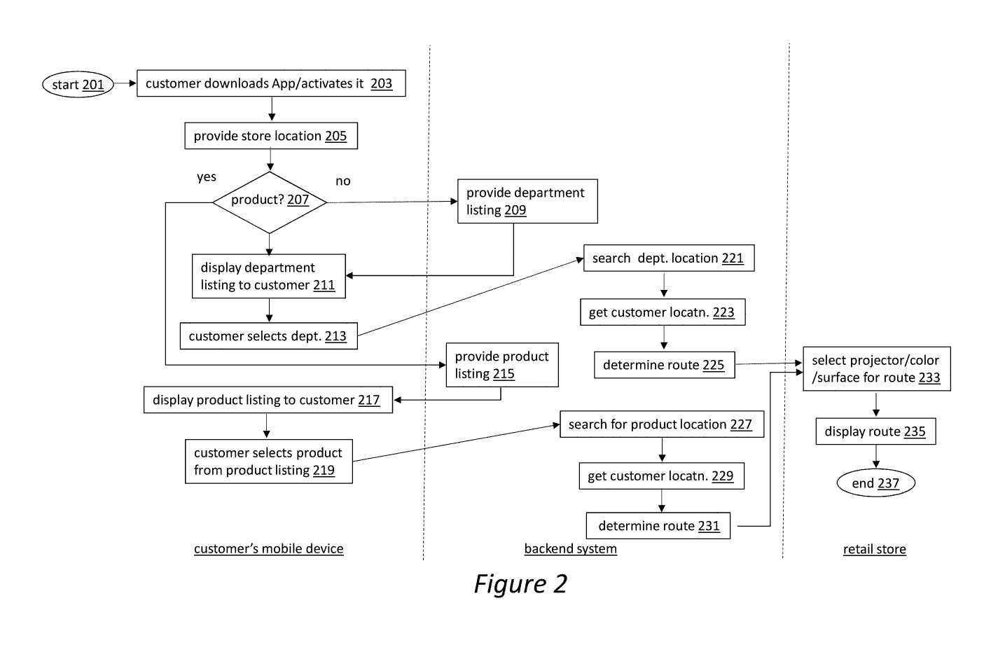

FIG. 2 is a flowchart illustrating the steps of a method according to the current invention.

The structure and functioning of the current invention will be described below in connection with FIGS. 1 and 2.

A location projector system 100 is shown in FIG. 1 for illuminating a route to a desired product, department or section of a large building, such as a retail store, is referred to as the target location 11, to assist a customer 5.

The process starts at step 201. In step 203 the customer downloads executable instructions, which may be an App on the customer's mobile device 110, and activates the App. The App is stored in memory 120 of customer's mobile device 110 in the executable code section 121. Also, other data 123 may be downloaded and stored in memory 120. Memory 120 also includes system scratch area 125 which can be used for calculations and temporary storage. The App runs on controller 115 that may interface with the customer through interface 113. Mobile device 110 may be a laptop, smart tablet, smart phone, or any other mobile computing device. The interface may include a touch screen on mobile device 110.

Interface 113 also has the capability to wirelessly communicate with interface 157 of backend system 150. Interface 157 of backend system 150 includes a controller 155 which runs the backend system 150 and has access to a retail store database 151 and item related database 153.

Controller 155 also can control at least one projector 131, preferably a plurality of small, ceiling—mounted pico projectors 131 capable of projecting lighted images 143 and various services, including reflective strips 141.

In step 205, the customer identifies a store in which the customer would like to find the desired product. This may be done by interacting with the customer through interface 113 by providing prompts to the user requesting location for a store. Alternatively, sensors 111 which may be GPS or other locating sensors may be employed to use the current location as a default location. Stores within a predetermined region around the location of interest will be displayed to the customer 5 and customer 5 may interact with interface 113 to select the store in which he is interested.

The customer mobile device 110 acquires the information as to where the store is by interacting through interface 157 with backend system 150 in which controller 155 searches through retail store database 151 to find stores in the proximity of the desired location.

Once the store location is identified, customer 5 may use the App to request a product, department, section, or location of the store in which the customer 5 is interested. Customer 5 can choose the granularity of the directions to be item-specific, or just a general department or location.

This information is provided to the customer's mobile device 110 which is forwarded through interface 157 to controller 155. Controller 155 interacts with an item related database 153 which pertains to the selected store. Controller 155 may now search through item related database 153 to find target locations 11 similar to that provided by customer 5.

In step 207 customer's mobile device 110 prompts customer 5 to indicate if the customer 5 is interested in a specific product 7 or other location.

If the customer 5 is not interested in the product, the backend system 150 generates and provides department listing to the mobile device 110.

in step 211, the department listing is displayed to the customer 5.

In step 213 customer interacts with interface 113 to select a department.

In step 221, the selected department is provided to controller 155 which searches item related database 153 to determine the department location.

In step 223 the customer's location is acquired by RF positioning, Wi-Fi positioning, or other conventional locating technology.

In step 225 controller 155 receives floor plan map of the selected store from retail store database 151 and uses the current customer location, the department location and the floor plan map to determine a route from the current location of customer 5 to the location of the selected department.

In step 233, controller 155 selects a color to use for this customer and the surface on which to project the route. The store projector system would be an array of application-controlled, ceiling-mounted, high-powered, miniature projectors or lasers.

Controller 155 then actuates at least one of the projectors 131 to project lighted images 143 on a surface such as reflective strips 141 to indicate a route from the current location of customer 5 to the target location 11. Customer 5 follows the lighted route and arrives at the target location 11.

In step 207, if customer 5 did in fact select a specific product (“yes”), processing continues at step 215.

In step 215, controller 155 of backend system 150 searches item related database 153 for the desired product. If more than one similar products are found, backend system 150 provides product listing to mobile device 110.

In step 217 this product listing is provided to customer 5 on interface 113.

In step 219, customer 5 selects one of the products which is provided back to controller 155.

In step 227 controller 155 searches item related database 153 to find the product and its location.

As indicated above, the location of customer 5 is determined in step 229.

In step 231 controller 155 employs a floor plan map of the selected store received from retail store database 151 and determines a route from the current location of customer 5 to the target location 11 of the selected product 7.

Processing then continues through steps 233 and 235 as indicated above.

The process ends at step 237.

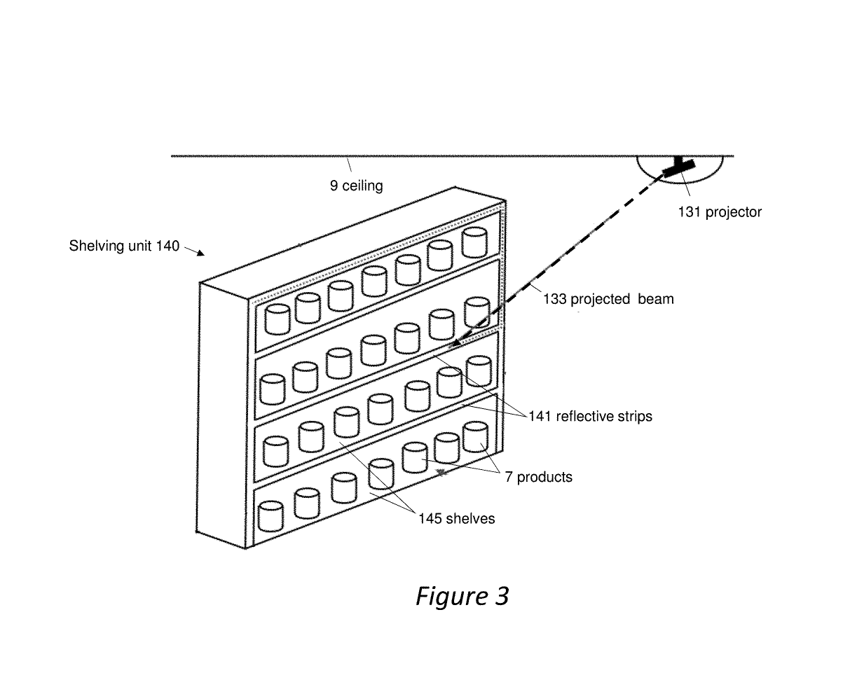

FIG. 3 is an illustration of the system projecting lighted indicators on reflective strips 141 on shelving to guide a customer to a target location 11. Here a single shelving unit 140 is shown. The reflective strips 141 can be special labels which act as projector screens that are attached to the tops and sides of every shelf of every aisle. This could include floors and various surfaces as well.

Shelving unit 140 has a plurality of shelves 145 which hold various products 7. These are situated throughout the store. One of the ceiling mounted projectors 131 projects a light beam 133 onto reflective strips 141 which are attached to the edges of the shelves 145 as shown in FIG. 3 or to any part of shelving unit 140. These reflective strips 141 may also be positioned on the floor, walls, signs, or any other visible surface within the store. Projector 131 projects lighted images 143 that may be arrow symbols, text or any other visual representation which can aid in directing the customer 5 along the route to the target location 11.

In an optional embodiment, the locating system may be used in an emergency situation such as a fire or bomb alert in which the customers are to evacuate the building. The locating system may act as a guidance system to direct customers to the nearest available exits. In this case, the location of the desired item/department will be replaced with the location of the nearest available exit, and a lighted path can be displayed for the customers to safely exit the building.

In another embodiment, paths from the major aisles to the nearest exit may be identified with lighted markers.

Since this system is intended to be operational in the event of a major disaster, it should have an alternative power supply so that it is functional when there is no electrical power in the store.

In an optional embodiment, the locating system may be used in case of a missing child. The system creates many lighted paths (and possibly blinking, lighted paths) to a safe location. The child is told over an intercom or by a phone text to follow the lighted path, or blinking lighted path to a meeting location. Since the system would not have information on the location of the child, it will light up paths on the major aisles and near most locations to the meeting locations.

The paths could be color coded so that the child could be instructed to follow the blue path to the safe area.

Optionally, in this situation, the controller 155 may be coupled to the automatic doors and enabled to lock all doors and exits, preventing the child from being abducted.

Although a few examples have been shown and described, it will be appreciated by those skilled in the art that various changes and modifications might be made without departing from the scope of the invention, as defined in the appended claims.

What is claimed is:

1. A method of illuminating a route to a desired product within a retail store to assist a customer having a mobile device in finding a desired product comprising the steps of:
activating executable code on the customer's mobile device;
identifying a store in which the customer would like to find the desired product;
interacting with an item related database of the identified store to find the location of the product, if it exists;
identifying a route to the product location;
operating at least one projector to project lighted markers indicating the route to follow to the product.

2. The method of claim 1, wherein the step identifying a route comprises the steps of:
determining a product location having more than a predetermined number of the desired product in stock; and
identifying a route to this product location.

3. The method of claim 1, wherein the step of identifying a store comprises one of the group consisting of:
manually inputting the store location into the customer's mobile device to identify the store, and
identifying the store associated with the customer's mobile device.

4. The method of claim 1, wherein the step of identifying a route comprises the steps of:
identifying the customer's current location; and
identifying a route from the customer's current location to the product location.

5. The method of claim 1, wherein the step of identifying a route comprises the steps of:
identifying a route from the entrance of the retail store to the product location.

6. The method of claim 1, wherein the step of operating at least one projector comprises the step of:
operating at least one projector to project markers on at least one of the group consisting of: floors, ceilings, shelving, reflective strips, and internal structures of the retail store indicating the route to follow to the product.

7. The method of claim 1 further comprising the step of:
notifying the customer if the product is not found in the item related database.

8. A method of illuminating a route to a desired product within a retail store to assist a customer in finding a desired department within a retail store comprising the steps of:
activating executable code on the customer's smartphone;
identifying a store in which to find the desired department;
interacting with an item related database of the identified store to find the location of the product, if it exists;
identifying a route to the department location;
operating at least one projector of a plurality of projectors mounted together, to project lighted markers indicating the route to follow to the department.

9. The method of claim 8, wherein the step of activating executable code comprises the steps of:
downloading executable code in the form of an App to the customer's mobile device; and
activating the App on the customer's mobile device.

10. The method of claim 8, wherein the step of identifying a store comprises one of the group consisting of:
manually inputting the store location into the customer's mobile device to identify the store, and
identifying the store associated with the customer's mobile device.

11. The method of claim 8, wherein the step of identifying a route comprises the steps of:
identifying the customer's current location; and
identifying a route from the customer's current location to the product location.

12. A locating system for assisting a customer having a mobile device, in finding a desired product within a retail store, the locating system employing a backend system comprising:
a retail store database having information on a plurality of retail stores and their locations and floorplan layouts;
at least one item related database having information on products offered by the stores in the retail store database;
at least one projector adapted to project lighted markers on a surface;
a controller coupled to the retail store database, adapted to:
receive information on a desired store from the customer's mobile device;
find the store in the retail store database corresponding to the received information;
access a layout for the retail store found;
receive information on the desired product in the desired store from the customer through the customer's mobile device;
find a product location in the item related database associated with the desired product, if it exists;
determine a route through the retail store layout to the product location; and
activate the projecting device to project lighted markers identifying the route.

13. The locating system of claim 12 wherein the at least one projector comprises a plurality of pico projectors that are mounted together to be redundant.

14. The locating system of claim 12 wherein the at least one projector is adapted to project lighted markers that include at least one of the group consisting of: arrows, symbols, icons, text and graphics.

15. The locating system of claim 12 wherein at least two of the plurality of pico projectors is positioned to project to overlapping locations to at least partially overlay their lighted markers.

16. The locating system of claim 12 wherein information on the desired store includes at least one of the group consisting of: a retail store closest to the customer's current location, a general location of the desired store, a portion of the address of the desired store, and a store number.

17. The locating system of claim 12 wherein the processor is further adapted to:
interact with the customer to acquire information on the desired store;
search the retail store database to find the closest matches to the acquired information;
provide the found matches to the customer mobile device to display to the customer; and
allow the customer to select one of the displayed matches as the desired store.

18. The method of claim 12, wherein the step of identifying a store comprises the steps of:
reading a geographic location calculated by the mobile device; and
searching a retail store database to identify at least one retail store near the geographic location;
presenting the retail stores near the geographic location to the customer; and
receiving customer input identifying the proper retail store.

19. The locating system of claim 12 wherein in an evacuation situation, the controller is further adapted to:
estimate customers' locations from their last known location;
determine a nearest available exit to each estimated customer's location from the store layout;
determine a route from the estimated customer locations through the retail store to the nearest available exit; and
activate the projecting device to project lighted markers identifying the determined route to the exits.

20. The locating system of claim 12 wherein in a missing child situation, the controller is further adapted to:
receive the child's approximate location;
determine a nearest safe ‘meetup location’;
determine a route from the estimated child's location through the retail store to the nearest ‘meetup location’;
notify the child over at least one of using an intercom, a voice message on a cell phone or text message on a cell phone to follow the lighted route; and
activate the projecting device to project lighted markers identifying the determined route to the ‘meetup location’.
